(19) United States
(12) Patent Application Publication
(10) Pub. No.: US 2014/0245526 A1
(43) Pub. Date: Sep. 4, 2014

(54) MOLDED FACEPIECE GASKET

(71) Applicant: Lion Apparel, Inc., (US)

(72) Inventor: Thomas S. Martin, Huber Heights, OH (US)

(73) Assignee: LION APPAREL, INC., Dayton, OH (US)

(21) Appl. No.: 13/624,329

(22) Filed: Sep. 21, 2012

Related U.S. Application Data
(60) Provisional application No. 61/538,334, filed on Sep. 23, 2011.

(51) Int. Cl. A62B 17/04

(52) U.S. Cl. CPC A62B 17/04
USPC 2/456; 2/455; 2/410

(57) ABSTRACT

A protective garment is disclosed that has a gasket directly molded to fabric that defines an opening in the garment. The opening may receive a wrist, a hand, an ankle, a neck, or face of a wearer. In one embodiment, the fabric is part of a hood and the gasket includes an interface feature for sealingly engaging a breathing or respiratory mask with an airtight seal, vapor-tight seal, moisture tight seal, or combinations thereof.

### TECHNICAL FIELD

This application is directed to protective garments having a gasket directly molded to the fabric thereof that defines an opening in the garment, and more particularly, to hoods that include a facepiece gasket molded directly to fabric defining the face opening in the hood.

### BACKGROUND

Protective or hazardous duty garments are used in a variety of industries and settings to protect the wearer from adverse conditions such as heat, flames, smoke, cold, sharp objects, chemicals, liquids, vapors, fumes and the like. When a protective or hazardous duty garment is intended for protection against chemical, biological, radiological, and/or nuclear threats, vapor tight and moisture tight seals for various aspects of the garment are important. Such seals are of importance where the garment fits about the wearer, such as at the wrist, hands, ankles, neck, and/or face. The face is typically covered by a breathing mask or respiratory mask.

Currently, as shown in the photograph of FIG. 1, the breathing mask or respiratory mask mates against a facepiece gasket that is sewn to the hood and may include seam tape to form a vapor tight and/or moisture tight seal between the fabric of the hood and the gasket material. This construction while effective is susceptible to wear, which may decrease the longevity of the hood. Sewing the facepiece gasket to the hood requires extensive preparation, which makes the manufacturing process more expensive.

### SUMMARY

A protective garment having a gasket directly molded to the fabric that defines an opening in the garment provides an improved seal to the fabric, a longer lasting seal to the fabric, and an interface seal to a breathing mask or respiratory mask that meets the National Fire Protection Association (“NFPA”) CBRN standards (chemical, biological, radiological, nuclear). The opening in the garment may be for a wrist, a hand, an ankle, the neck, or the face of the wearer. In one embodiment, the fabric forms a hood of the garment and the gasket is directly molded to the fabric defining an opening for the face of the wearer. The protective garment may be a coat or a one-piece suit with a fixed or a sealingly, detachable hood.

The gasket is directly molded to both the outer surface and the inner surface of the fabric. In cross-section, the fabric provides a tongue inside a groove defined by an upper rail and a lower rail of gasket material. As the gasket material extends away from the fabric, the upper rail and lower rail of gasket material merge into a primary body of the gasket material. The primary body has a first thickness, the upper rail has a second thickness and the lower rail has a third thickness. In one embodiment, the first thickness is smaller than the sum of the second and third thicknesses.

The fabric that the gasket material is molded to provides vapor and particulate protection against chemical, biological, radiological, and nuclear threats in the form of toxic industrial chemicals, toxic industrial materials, and chemical warfare agents. The protective garment, as a whole, is certified to one or more of NFPA 1994 Class 2 and NFPA 1994 Class 3 standards.

In one aspect, the fabric that the gasket is directly molded to is a strip of fabric or a ring of fabric connectable to the opening in the garment.

### BRIEF DESCRIPTION OF THE DRAWINGS

FIG. 1 is a prior art hood having an interface mask seal sewn to the fabric of the hood.

FIG. 2 is a front view of a one-piece protective garment with a removeably attachable hood that includes a facepiece gasket molded directly to the fabric of the hood.

FIG. 3 is a cross-section of a portion of the hood with the molded facepiece gasket of FIG. 2 taken along line 3-3.

FIG. 4 is an alternate embodiment of a cross-section of a portion of a hood as if taken along line 3-3 in FIG. 2.

FIG. 5A is a top view of a ring of fabric having a gasket molded directly thereto.

FIG. 5B is a top view of a strip of fabric having a gasket molded directly thereto.

FIG. 6 is a front view of one embodiment of a protective garment having a hood with a facepiece gasket molded directly thereto.

### DETAILED DESCRIPTION

The following detailed description will illustrate the general principles of the invention, examples of which are additionally illustrated in the accompanying drawings. In the drawings, like reference numbers indicate identical or functionally similar elements.

The garments and hoods disclosed herein have a gasket molded directed to the fabric or material forming an opening in the garment. For example, the opening may be one that receives a wrist, a hand, an ankle, the neck, or the face of the wearer. The direct molding of the gasket to the fabric provides an improved seal that is easier to manufacture and has greater longevity than its sewn predecessor. While the gasket is primarily described herein with respect to the hood of a garment, the seal is not so limited. The seal may be utilized by molding seal material to any opening defined by a portion of the garment or to a strip or ring of fabric that is connectable to such openings. The molding process results in the gasket being molded directly to both an inner surface and an outer surface of the fabric or material defining the opening in the garment.

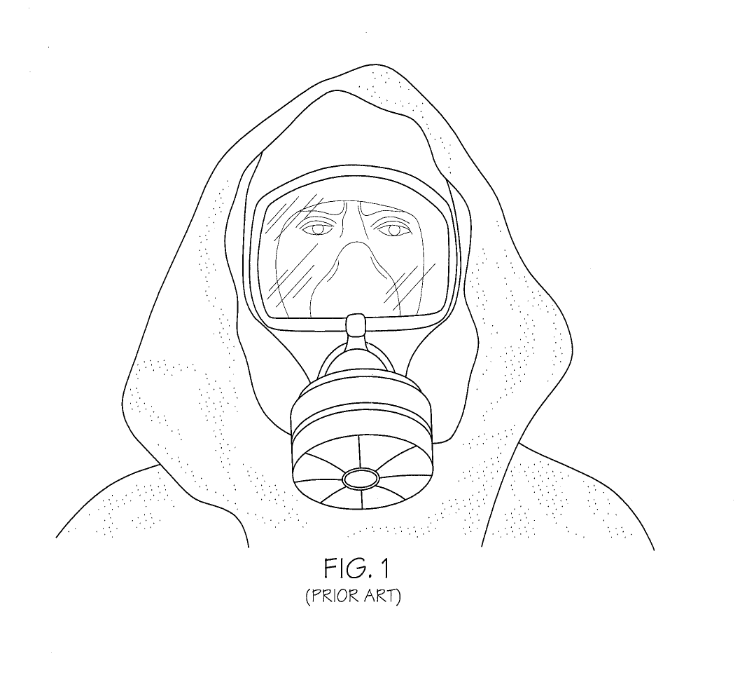

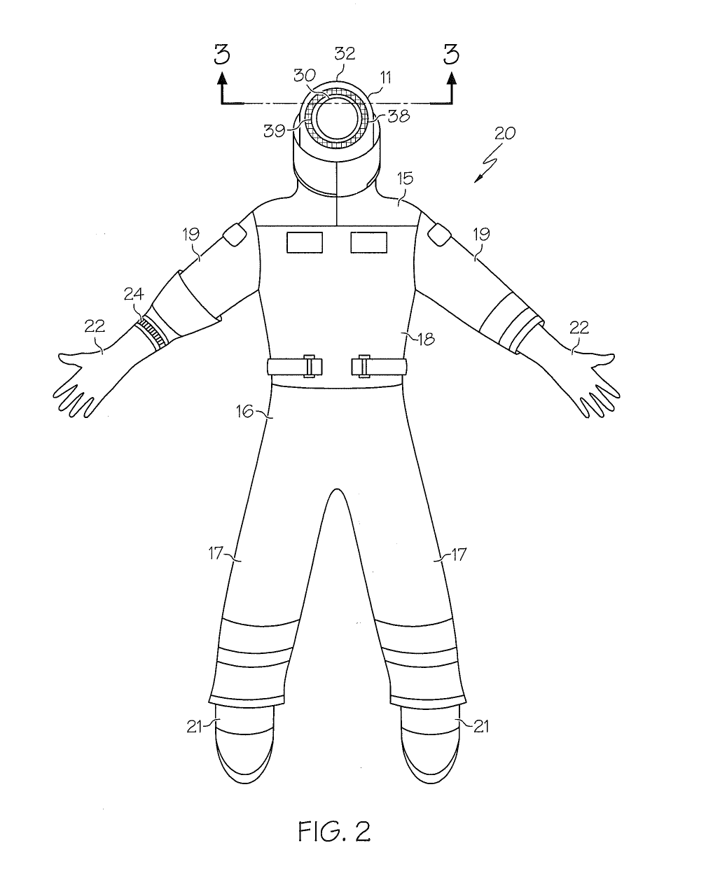

Referring to FIG. 2, the protective or hazardous duty garment in one embodiment is a one-piece suit 20 that is detachably, sealingly connected to a hood 11. In other embodiments, the hood 11 may be permanently connected to the garment. The hood 11 includes a head-covering portion 32 that defines an opening 30 for the face of the wearer. The wearer of such hoods often dons a breathing mask or respiratory mask such as that shown in FIG. 1. It is important to form an airtight, vapor-tight, and/or moisture tight connection between the breathing mask or respiratory mask and the hood 11. To enhance this connection, the hood 11, as illustrated in FIG. 2, includes a facepiece gasket 38 formed by directly molding a seal material 39 to the fabric or material that defines the opening 30 in the hood 11. Accordingly, the breathing mask or respiratory mask interfaces with the facepiece gasket 38 to provide a seal that is sufficiently airtight, vapor-tight, and/or moisture tight to meet and pass the NFPA Chem/Bio Option specifications described below.

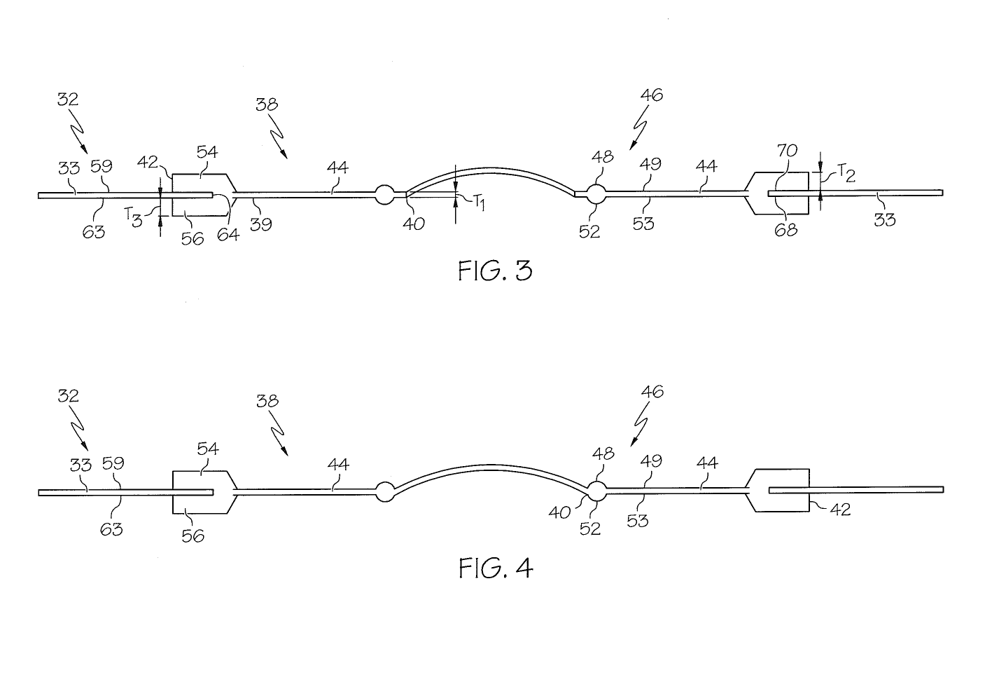

A cross-section of a portion of hood 11 taken along line 3-3 in FIG. 2 is included as FIG. 3 and as the alternate embodiment in FIG. 4. As labeled in FIG. 3, the facepiece gasket 38 has an inner periphery 40 and an outer periphery 42. Between the inner periphery 40 and the outer periphery 42 is the primary body portion 44 which frames the wearer's face when donned. Near the inner periphery 40, the facepiece gasket 38 may include an interface feature 46 that enhances the airtight, vapor-tight, and/or moisture tight connection between the breathing mask or respiratory mask and the facepiece gasket 38. The interface feature 46 is described in detail below. The outer periphery 42 of the facepiece gasket 38 is molded to the fabric 33 that defines opening 30.

As shown in FIGS. 3 and 4, the outer periphery 42 of the interface mask seal 38 is molded to the fabric 33 with the fabric interposed between an upper rail 54 of seal material and a lower rail 56 of seal material, which are both directly molded to the fabric 33. As such, the upper rail 54 of seal material is directly molded to the outer surface 59 of fabric 33 and the lower rail 56 of seal material is directly molded to the inner surface 63 of fabric 33. The fabric 33 appears in these cross-sections as a tongue 68 (see FIG. 3) inside a groove 70 defined by the upper rail 54 and the lower rail 56 of gasket material. The upper and lower rails 54, 56 may be molded over an equal or a different amount of surface area of the fabric 33. In one embodiment, the surface areas covered are different and the lower rail 56 covers a larger surface area of the fabric 33 than the upper rail 54. The rails 54, 56 may cover, measuring from the edge 64 (see FIG. 3) of the fabric 33, about 0.25″ to about 1.0″ of the fabric 33. In another embodiment, the upper and lower rails 54, 56 may cover about 0.5″ to about 0.75″ of the fabric 33. Overall, the facepiece gasket 38 may be about 1.5″ to about 6″ wide.

The upper and lower rails 54, 56 merge and gradually taper, once beyond the edge 64 of the fabric 33, to a primary body portion 44 having a first thickness T₁. The upper rail 54 has a second thickness of T₂ and the lower rail 56 has a third thickness of T₃. In one embodiment, the first thickness T₁ of the primary body portion 44 is smaller than the sum of the second and third thicknesses T₂ and T₃. The second and third thicknesses T₂ and T₃ may be the same or different. In another embodiment, both the second and third thicknesses T₂ and T₃, individually, are greater than the first thickness T₁.

Turning now to the interface feature 46 illustrated in FIGS. 3 and 4, the facepiece gasket 38 may include an interface feature 46 that assists in forming an air tight, vapor-tight, and/or moisture tight seal with a breathing mask or a respiratory mask. The interface feature 46 may have numerous configurations and shapes that will enhance the seal between the facepiece gasket 38 and a breathing mask or respiratory mask. The interface feature 46 may include a first protruding ridge 48 and optionally a second protruding ridge 52, but is not limited thereto. In one embodiment, the first protruding ridge 48 is on the outer surface 49 of the primary body portion 44 proximate the inner periphery 40 (FIG. 3) or at the inner periphery 40 (FIG. 4). The second protruding ridge 52 may be on the inner surface 53 of the primary body portion 44 opposite the first protruding ridge 48. In another embodiment, the second protruding ridge 52 may be offset inward or outward relative to the position of the first protruding ridge 48. While FIGS. 3 and 4 illustrate a single first protruding ridge 48 and a single second protruding ridge 52, the interface feature 46 is not limited thereto and may include a plurality of such ridges. In one embodiment, the first and second protruding ridges 48, 52 extend 360° about the inner periphery. In other embodiment, the first and second protruding ridges 48 may extend more than or less than 360° about the inner periphery.

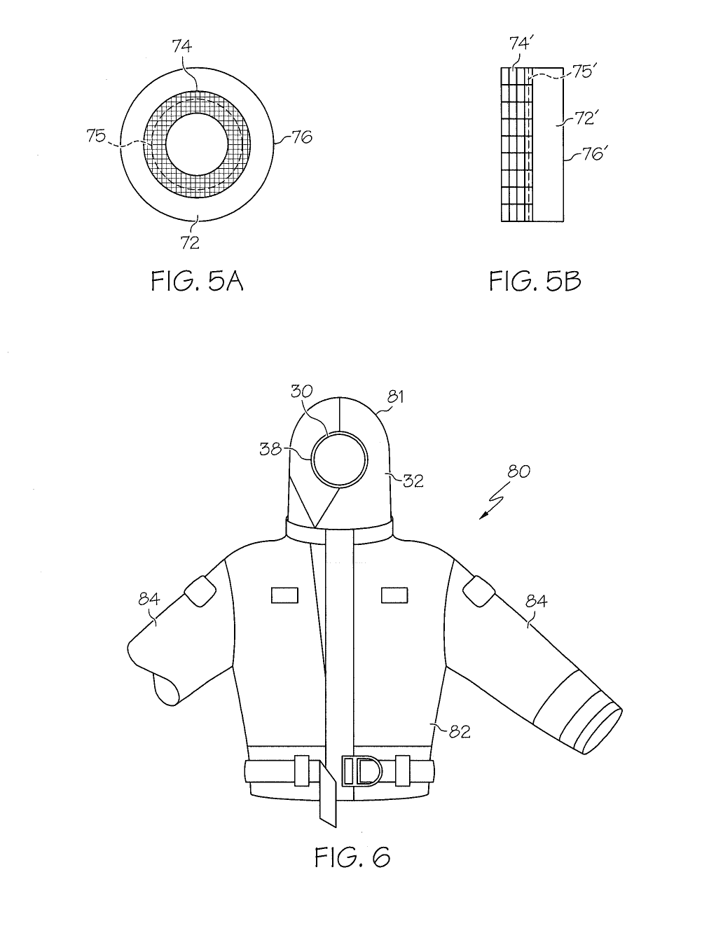

In one aspect, as shown in FIG. 5, the invention may be in the form of a ring 72 or a strip 72′ of fabric or material that has an inner periphery 75, 75′ and an outer periphery 76, 76′, respectively and a gasket 74, 74′ directly molded to the inner periphery 75, 75′. The strip or ring of fabric 72, 72′ is wide enough to have the gasket 74, 74′ molded thereto and to provide enough non-molded fabric for connection to an opening in a garment, such as the opening for the face in the hood 11 or for the wrist in the arm portion 19 of FIG. 2. In one embodiment, the strip or ring of fabric 72 is about 2.0″ to about 8″ wide. The strip or ring of fabric 72, 72′ is permanently connectable to the opening in a garment, for example, by sewing, adhering, or the like.

The one-piece suit 20 of FIG. 2 includes an upper leg portion 16 configured to receive the lower part of the torso and the upper part of the legs of a wearer, leg portions 17 configured to receive the lower part of the leg of a wearer, torso portion 18 configured to receive the chest and abdomen of a wearer, arm portions 19 configured to receive the arms of a wearer, and booties 21 configured to receive the feet of a wearer. The suit 20 may include gloves 22 that may be sealingly, detachably connectable to the arm portions 19 by gasket 24, which is directly molded to the fabric or material defining an opening in the arm portion 19. Similarly, the leg portions 17 proximate to the ankle region may include a gasket (not shown) directly molded to the fabric or material defining an opening in the leg portions 17.

Now referring to FIG. 6, the protective or hazardous duty garment 80 may be any of the following non-limiting examples, a jacket, coat, shirt, or pullover undergarment that include a torso portion 82 and arm portions 84. The arm portions 84 may be detachably, sealingly connectable to gloves, for example gloves 22 in FIG. 2. The garment 80 includes a hood, designated as 81, that, similar to hood 11 of FIG. 2, has a facepiece gasket 38 formed by directly molding a seal material to the fabric that defines the opening 30 in the head-covering portion 32 of the hood.

The gaskets herein may be molded to the fabric using known molding techniques such as, but not limited to, injection molding, compression molding, rotational molding, and blow molding. A mold is provided that has the designed configuration for the gasket. The mold is also designed to receive the opening of the garment or the strip or ring of fabric 72, 72′ in a manner that the fabric will remain in place within the mold as the gasket material is over-molded onto the fabric, in particular, both the upper and lower surfaces of the fabric as described above.

The gaskets disclosed herein include a rubber material, including natural and/or synthetic rubbers. In one embodiment, the rubber material includes, but is not limited to, butyl rubber, chloro-butyl rubber, silicone rubber, chloroprene rubber, ethylene propylene diene monomer (“EPDM”) rubber, nitril rubber, or blends thereof.

The fabric or material used for the protective garment 20, the hood 11, the strip or ring of fabric 72, 72′, and the garment 80 is generally a material that provides vapor and particulate protection against chemical, biological, radiological, and nuclear threats in the form of toxic industrial chemicals, toxic industrial materials, and chemical warfare agents. The fabric or material may be or include a semi-permeable (selectively permeable) or impermeable membrane material. The selectively permeable membrane material may be generally water vapor permeable but generally impermeable to other liquid moisture. The fabric may be made of a microporous material that is either hydrophilic, hydrophobic, or somewhere in between, a monolithic material that allows moisture vapor transmission therethrough by molecular diffusion, or a combination thereof (known as a bicomponent moisture barrier in which the microporous or monolithic materials are layered or intertwined). The membrane material may be made of or include expanded polytetrafluoroethylene such as GORE-TEX® or CROSSTECH® materials (both of which are trademarks of W.L. Gore & Associates, Inc. of Newark, Del.), polyurethane-based materials, neoprene-based materials, cross-linked polymers, polyamid, GORE® CHEMPAK® materials sold by W.L. Gore & Associates, Inc., which include GORE® CHEMPAK® Ultra Barrier Material, GORE® CHEMPAK® Selectively Permeable Material, or GORE® CHEMPAK® Sorptive Material, Tychem® material sold by Dupont, fabric or cloth that includes carbon such as those sold by Calgon Carbon Corporation of Pittsburg, Pa., or other suitable materials. In one embodiment, the garment or hood may be or include a GORE™, Chempak® Ultra Barrier Material laminated to an outer shell of NOMEX® textile.

The garments 20, 80 as a whole may meet the National Fire Protection Association (“NFPA”) standards for chemical, biological, radiological, and nuclear (CBNR) threats. Such harmful materials may include liquids (including chemical warfare agents, biological warfare agents and toxic industrial chemicals), vapors and aerosols (including chemical warfare agents and toxic industrial chemicals), and contaminated particulates (such as biological warfare agents or toxic industrial materials). Examples of chemical warfare agents include soman (GD) nerve agent and distilled mustard (HD) blister agent. Examples of toxic industrial chemicals include acrolein (liquid), acrylonitrile (liquid), ammonia (gas), choline (gas), and dimethyl sulfate (liquid). In one embodiment, the protective garment is certified to the NFPA 1994 Class 2 standard, the NFPA Class 3 standard, or both standards (the entire contents of which are hereby incorporated by reference).

In one embodiment, the garment must pass a Man In Simulant Test (“MIST”). In one case, the MIST essentially consists of introducing the garment into a chamber filled with a vaporized test material (such as oil of wintergreen). Absorbent padding is placed on the wearer and/or inside the garment. After the garment has been exposed to the vaporized material for a sufficient period of time, the garment is removed from the chamber. The absorbent pads are removed and analyzed to determine how much of the vaporized test material they have absorbed, if any.

Depending on the application of the garments 20 and 80, the garments may include various layers through their thicknesses to provide various heat, moisture, chemical, and abrasion resistant qualities so that the garments can be used as a protective, hazardous duty, and/or firefighter garment. Materials suitable for such protective suits are known in the art and are disclosed in U.S. Pat. No. 7,395,555, herein incorporated by reference in its entirety.

Although the invention is shown and described with respect to certain embodiments, it should be clear that modifications will occur to those skilled in the art upon reading and understanding the specification, and the present invention includes all such modifications.

What is claimed is:

1. A protective garment comprising:
a gasket directly molded to fabric that defines an opening in the garment.

2. The protective garment of claim 1 wherein the opening is one that receives a wrist, a hand, an ankle, a neck, or a face of the wearer.

3. The protective garment of claim 1, wherein the gasket is molded to both the outer surface and the inner surface of the fabric.

4. The protective garment of claim 3, wherein, in cross-section, the fabric molded to the gasket appears as a tongue inside a groove defined by an upper rail and a lower rail of gasket material.

5. The protective garment of claim 4, wherein the upper rail and lower rail of gasket material merge into a primary body of the gasket material extending away from the fabric, the primary body having a first thickness, the upper rail having a second thickness and the lower rail having a third thickness, wherein the first thickness is smaller than the sum of the second and third thicknesses.

6. The protective garment of claim 4, wherein the upper rail and lower rail are molded over an equal amount of surface area of the fabric.

7. The protective garment of claim 4, wherein the upper rail and lower rail are molded over a different amount of surface area of the fabric.

8. The protective garment of claim 7, wherein the lower rail covers a greater amount of surface area of the fabric.

9. The protective garment of claim 1, wherein the fabric provides vapor and particulate protection against chemical, biological, radiological, and nuclear threats in the form of toxic industrial chemicals, toxic industrial materials, and chemical warfare agents.

10. The protective garment of claim 1, wherein the opening is one that receives the face of the wearer and the gasket defines an interface feature for sealingly engaging a breathing or respiratory mask with an airtight seal, vapor-tight seal, moisture tight seal, or combinations thereof.

11. The protective garment of claim 1, wherein the gasket includes a rubber material.

12. The protective garment of claim 10, wherein the interface feature includes a first protruding ridge on the outer surface of the gasket at or proximate to the inner periphery that defines the opening, the first protruding ridge extending at least 360° about the opening.

13. The protective garment of claim 12, wherein the interface feature further includes a second protruding ridge on the inner surface of the gasket opposite the first protruding ridge.

14. The protective garment of claim 1, wherein the protective garment is certified to one or more of NFPA 1994 Class 2 and NFPA 1994 Class 3 standards.

15. The protective garment of claim 1, wherein the fabric the gasket is directly molded to is a strip of fabric or a ring of fabric connectable to the opening in the garment.

16. The protective garment of claim 1, wherein the fabric is a ring of fabric that is generally circular.

17. The protective garment of claim 1, wherein the garment is a coat or a one-piece suit connectable to the hood.

18. A protective garment comprising:
a hood, the hood having a facepiece gasket directly molded to fabric of the hood that defines an opening in the garment for receiving the face of a wearer;
wherein the facepiece gasket defines an interface feature for sealingly engaging a breathing or respiratory mask with a vapor resistant seal, a liquid resistant seal, or combinations thereof.

19. The protective garment of claim 1, wherein the fabric that the gasket is directly molded to is a strip of fabric or a ring of fabric connectable to the opening in the garment.
